(19) United States
(12) Patent Application Publication
(10) Pub. No.: US 2023/0308658 A1
(43) Pub. Date: Sep. 28, 2023

(54) METHODS OF PARAMETER SET INDICATION IN VIDEO STREAMING

(71) Applicant: Tencent America LLC, Palo Alto, CA (US)

(72) Inventors: Xiaozhong XU, State College, PA (US); Shan LIU, San Jose, CA (US)

(73) Assignee: Tencent America LLC, Palo Alto, CA (US)

(21) Appl. No.: 17/973,986

(22) Filed: Oct. 26, 2022

Related U.S. Application Data
(60) Provisional application No. 63/323,846, filed on Mar. 25, 2022.

(51) Int. Cl. H04N 19/157; H04N 19/132; H04N 19/172; H04N 19/136; H04N 19/103

(52) U.S. Cl. CPC H04N 19/157; H04N 19/132; H04N 19/172; H04N 19/136; H04N 19/103

(57) ABSTRACT

This disclosure relates generally to video coding and particularly to video file encapsulation and parameter signaling. For example, a method is disclosed for processing video data which may include receiving a bitstream comprising at least one video sample, the at least one video sample comprising a current video sample and a previous video sample, wherein each video sample comprises at least one video frame, and wherein each video sample is associated with a serving SPS for decoding the each of the at least one video sample; determining the serving SPS for the current video sample as being one of: a previous SPS already parsed from the bitstream and used for decoding the previous video sample; a current SPS encapsulated in the current video sample; and an SPS in a list of candidate SPSs; and decoding the current video sample based on the serving SPS for the current video sample.

### INCORPORATION BY REFERENCE

This application is based on and claims the benefit of priority to U.S. Provisional Application No. 63/323,846, entitled “Method and Apparatus for Parameter Set Indication in Video Streaming”, filed on Mar. 25, 2022, which is herein incorporated by reference in its entirety.

### TECHNICAL FIELD

This disclosure describes a set of advanced video coding technologies. More specifically, the disclosed technology involves implementation of and enhancement on video file encapsulation for video bitstream, as well as decoding parameter signaling.

### BACKGROUND

This background description provided herein is for the purpose of generally presenting the context of the disclosure. Work of the presently named inventors, to the extent the work is described in this background section, as well as aspects of the description that may not otherwise qualify as prior art at the time of filing of this application, are neither expressly nor impliedly admitted as prior art against the present disclosure.

A multimedia system may include modules supporting following procedures: video capturing, video coding, video file encapsulation, file transport, file decapsulation, video decoding and video rendering. Among these procedures, file encapsulation is used to organize the original video bitstream with essential metadata information in order to optimize the transport and decoding procedure. During file encapsulation, video frames in the bitstream are usually redefined as samples (or video samples) in the file, typically, a sample can be considered as a video frame with additional metadata such as frame size, presentation time, etc.

Video coding and decoding can be performed using inter-picture prediction with motion compensation. Uncompressed digital video can include a series of pictures, with each picture having a spatial dimension of, for example, 1920×1080 luminance samples and associated full or subsampled chrominance samples. The series of pictures can have a fixed or variable picture rate (alternatively referred to as frame rate) of, for example, 60 pictures per second or 60 frames per second. Uncompressed video has specific bitrate requirements for streaming or data processing. For example, video with a pixel resolution of 1920×1080, a frame rate of 60 frames/second, and a chroma subsampling of 4:2:0 at 8 bit per pixel per color channel requires close to 1.5 Gbit/s bandwidth. An hour of such video requires more than 600 GBytes of storage space.

One purpose of video coding and decoding can be the reduction of redundancy in the uncompressed input video signal, through compression. Compression can help reduce the aforementioned bandwidth and/or storage space requirements, in some cases, by two orders of magnitude or more. Both lossless compression and lossy compression, as well as a combination thereof can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application albeit some information loss. In the case of video, lossy compression is widely employed in many applications. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

A video encoder and decoder can utilize techniques from several broad categories and steps, including, for example, motion compensation, Fourier transform, quantization, and entropy coding.

### SUMMARY

Aspects of the disclosure relates generally to video encoding and decoding, and particularly, to implementation of and enhancement on video file encapsulation for video bitstream, as well as decoding parameter signaling.

Aspects of the disclosure provides a method for processing video data. The method includes receiving a bitstream comprising at least one video sample, the at least one video sample comprising a current video sample and a previous video sample, wherein each of the at least one video sample comprises at least one video frame, and wherein the each of the at least one video sample is associated with a serving sequence parameter set (SPS) for decoding the each of the at least one video sample; determining the serving SPS for the current video sample as being one of: a previous SPS already parsed from the bitstream and used for decoding the previous video sample; a current SPS encapsulated in the current video sample; and an SPS in a list of candidate SPSs; and decoding the current video sample based on the serving SPS for the current video sample.

Aspects of the disclosure also provide a video encoding or decoding device or apparatus including a circuitry configured to carry out any of the method implementations above.

Aspects of the disclosure also provide non-transitory computer-readable mediums storing instructions which when executed by a computer for video decoding and/or encoding cause the computer to perform the methods for video decoding and/or encoding.

### BRIEF DESCRIPTION OF THE DRAWINGS

Further features, the nature, and various advantages of the disclosed subject matter will be more apparent from the following detailed description and the accompanying drawings in which:

FIG. 1 shows a diagram of an exemplary application environment of a video encoding/decoding method;

FIG. 2 shows various example video samples;

FIG. 3 shows a schematic illustration of a simplified block diagram of a communication system (300) in accordance with an example embodiment;

FIG. 4 shows a schematic illustration of a simplified block diagram of a communication system (400) in accordance with an example embodiment;

FIG. 5 shows a schematic illustration of a simplified block diagram of a video decoder in accordance with an example embodiment;

FIG. 6 shows a schematic illustration of a simplified block diagram of a video encoder in accordance with an example embodiment;

FIG. 7 shows a block diagram of a video encoder in accordance with another example embodiment;

FIG. 8 shows a block diagram of a video decoder in accordance with another example embodiment;

FIG. 9 shows a flow chart of method according to an example embodiment of the disclosure; and

FIG. 10 shows a schematic illustration of a computer system in accordance with example embodiments of the disclosure.

### DETAILED DESCRIPTION OF EMBODIMENTS

The invention will now be described in detail hereinafter with reference to the accompanied drawings, which form a part of the present invention, and which show, by way of illustration, specific examples of embodiments. Please note that the invention may, however, be embodied in a variety of different forms and, therefore, the covered or claimed subject matter is intended to be construed as not being limited to any of the embodiments to be set forth below. Please also note that the invention may be embodied as methods, devices, components, or systems. Accordingly, embodiments of the invention may, for example, take the form of hardware, software, firmware or any combination thereof.

Throughout the specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

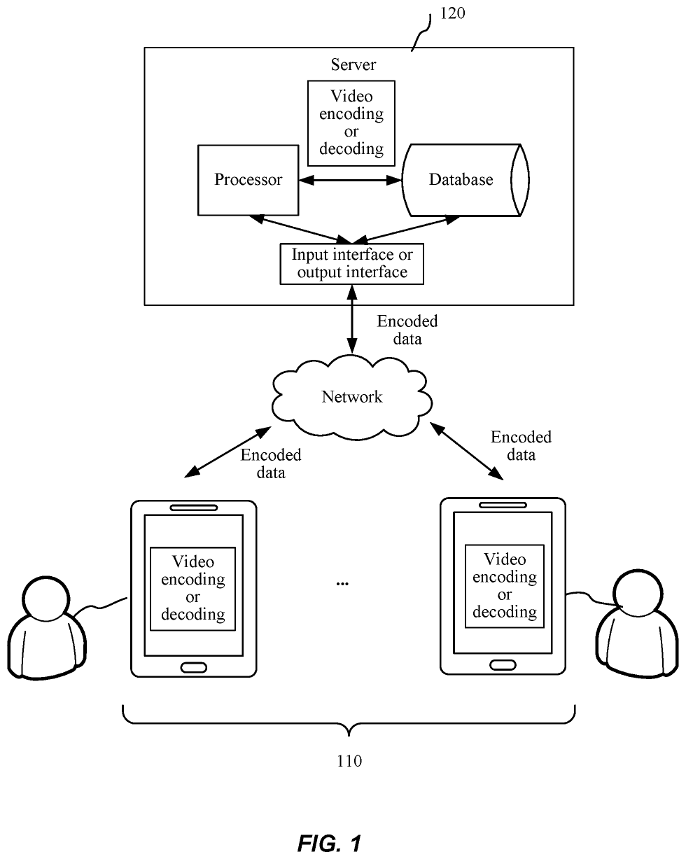

FIG. 1 is a diagram of an application environment of a video processing (encoding/decoding) method according to an embodiment. Referring to FIG. 1, the video processing method is applied to a video processing system. The video processing system includes a terminal 110 and a server 120. The terminal 110 is connected to the server 120 by a network. The terminal 110 may be, but is not limited to, a desktop terminal or a mobile terminal, and the mobile terminal may be specifically at least one of a mobile phone, a tablet computer, a notebook computer, and the like, and there is no limitation imposed in this application. The server 120 may be implemented by using an independent server or a server cluster that includes a plurality of servers. A terminal may also be referred to as a client.

The video encoding method and the video decoding method may be implemented in the terminal 110 and/or the server 120. The terminal 110 may encode a current frame by using the video encoding method, and then transmit the encoded video frame to the server 120, or receive encoded data (e.g., bitstream) from the server 120, decode the encoded data by using the video decoding method, and then generate a reconstructed video frame. The server 120 may perform transcoding on a code stream during storage. In this case, the video encoding method is completed on the server. If the server 120 needs to decode the code stream, the video decoding method is completed on the server. It may be understood that an encoding end and a decoding end may be the same end or different ends. The computer device, for example, a terminal or a server, may be an encoding end or a decoding end, or both an encoding end and a decoding end.

Referring to FIG. 1, the terminal 110 or the server 120 may perform video encoding by using an encoder or video decoding by using a decoder. The terminal 110 or the server 120 may also perform video encoding by using a processor running a video encoding program or video decoding by using a processor running a video decoding program. For example, after receiving, through an input interface, encoded data transmitted by the terminal 110, the server 120 may directly transfer the encoded data to the processor for decoding, or may store the encoded data in a database for subsequent decoding. After obtaining encoded data by encoding an original video frame by the processor, the server 120 may directly transmit the encoded data to the terminal 110 through an output interface, or may store the encoded data in a database for subsequent transfer.

In example implementations, the video encoding method and the video decoding method provided in this disclosure may be applied to applications such as video on demand or video streaming. In such applications, as an example, the terminal may send a request to the server to play a video. The server may fetch source data from the database, the video source may be pre-encoded video data, or the server may encode the video source to obtain encoded video data in real time, for example, to meet a certain service requirement and/or transmission bandwidth. The server may then transmit encode video data via bitstream to the terminal. The terminal may also support multiple play mode, such as fast forward, rewind, or jump (e.g., by clicking on a new time point in the timeline, or drag the playhead in the timeline to a new time point). The jump play involved random access function, which will be described in details in later sections.

In example implementations, the video encoding method and the video decoding method provided in this disclosure may be applied to an application having a video call function. The application may include a social application or an instant messaging application. During a video call between two terminals installed with embodiments of the application, a first terminal acquires a video frame by using a camera, encodes the video frame by using a video encoding function of an application, to obtain encoded data, and transmits the encoded data to a background server of the application. The background server forwards the encoded data to a second terminal. After receiving the encoded data, the second terminal decodes the encoded data by using a video decoding function of the application, and performs reconstruction to obtain a video frame, so as to display the video frame. Similarly, the second terminal may transmit the encoded data obtained through encoding to the first terminal by using the background server, and the first terminal performs decoding and display, thereby implementing a video call between the two parties.

In example implementations, the video encoding method and the video decoding method provided in this application may be applied to an application having a video playback function. For example, the application may include a video live streaming application, a short video application or a video playback application. A terminal installed with embodiments of the application may acquire a video frame by using a camera, encode the video frame by using a video encoding function of the application, to obtain encoded data, and transmit the encoded data to a background server of the application. If another terminal requests to watch the video, the background server transmits encoded data of the video to the other terminal. An application on the other terminal decodes the encoded data, to play the video.

The foregoing several possible application scenarios are only used for exemplary description. The video encoding method and video decoding method provided in various embodiments of the present disclosure may further be applied to any scenarios that require video encoding and decoding.

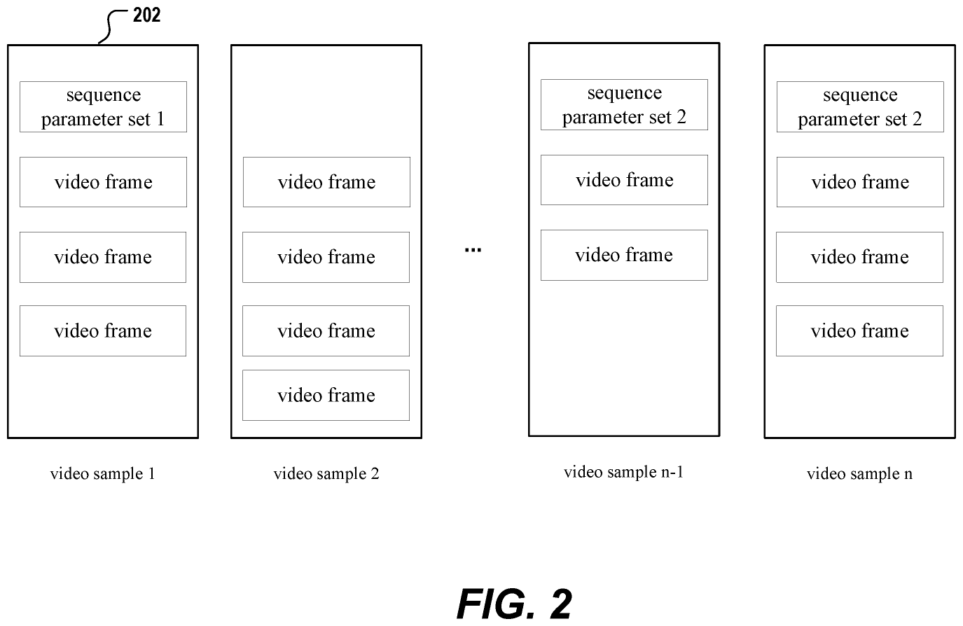

FIG. 2 shows an exemplary high level video bitstream structure. A bitstream may include n video samples (202). Each video sample is formed by at least one video frame. In one implementation, the number of video frames in each video sample may be a variable. In one implementation, the number of video frames in each video sample may be fixed (e.g., each video sample may include 1 video frame, or each video sample may include 2 video frames, etc.). In one implementation, each video sample may be encapsulated in one data packet for transmission (e.g., an internet protocol (IP) packet). In one implementation, each video frame may be encapsulated in one data packet.

In example implementations, multiple adjacent video samples that share a same sequence parameter set (SPS, also referred to as sequence level parameter set) may form a video sequence (or sequence, coded video sequence). Referring to FIG. 2, video sample 1 and video sample 2 may form a sequence, and the sequence includes all the frames in both video samples. Video frame n−1 and video frame n may form another sequence. A video sample may further encapsulate an SPS that may be used to decode the video samples in a same sequence. The SPS may be encapsulated in only one video sample in a sequence, such as the start video sample in the sequence. The SPS may also be encapsulated in all video samples in a sequence. Detailed implementations will be described in later sections. In this disclosure, decoding a video sample includes decoding all the frames in the video sample. As an example, a bitstream may include n video samples with n being a positive integer, each video sample may include 1 video frame, and the n video samples may form multiple sequences.

In this disclosure, a video sequence may be formed by a single video sample.

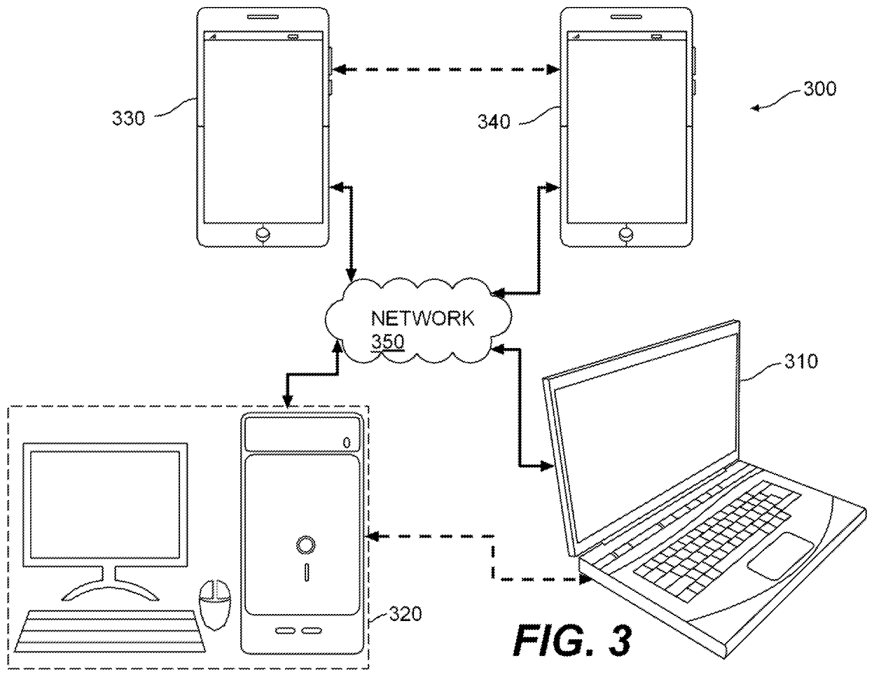

FIG. 3 illustrates a simplified block diagram of a communication system (300) according to an embodiment of the present disclosure. The communication system (300) includes a plurality of terminal devices that can communicate with each other, via, for example, a network (350). For example, the communication system (300) includes a first pair of terminal devices (310) and (320) interconnected via the network (350). In the example of FIG. 3, the first pair of terminal devices (310) and (320) may perform unidirectional transmission of data. For example, the terminal device (310) may code video data (e.g., of a stream of video pictures that are captured by the terminal device (310)) for transmission to the other terminal device (320) via the network (350). The encoded video data can be transmitted in the form of one or more coded video bitstreams. The terminal device (320) may receive the coded video data from the network (350), decode the coded video data to recover the video pictures and display the video pictures according to the recovered video data. Unidirectional data transmission may be implemented in media serving applications and the like. Note that the terminal device (310) may also retrieve pre-encoded video data directly from an internal/external storage and/or an internal/external database. In this case, the encoding process may be skipped and the terminal device (310) may transmit the video bitstream directly to the terminal device (320).

In another example, the communication system (300) includes a second pair of terminal devices (330) and (340) that perform bidirectional transmission of coded video data that may be implemented, for example, during a videoconferencing application. For bidirectional transmission of data, in an example, each terminal device of the terminal devices (330) and (340) may code video data (e.g., of a stream of video pictures that are captured by the terminal device) for transmission to the other terminal device of the terminal devices (330) and (340) via the network (350). Each terminal device of the terminal devices (330) and (340) also may receive the coded video data transmitted by the other terminal device of the terminal devices (330) and (340), and may decode the coded video data to recover the video pictures and may display the video pictures at an accessible display device according to the recovered video data.

In the example of FIG. 3, the terminal devices (310), (320), (330) and (340) may be implemented as servers, personal computers and smart phones but the applicability of the underlying principles of the present disclosure may not be so limited. Embodiments of the present disclosure may be implemented in desktop computers, laptop computers, tablet computers, media players, wearable computers, dedicated video conferencing equipment, and/or the like. The network (350) represents any number or types of networks that convey coded video data among the terminal devices (310), (320), (330) and (340), including for example wireline (wired) and/or wireless communication networks. The communication network (350) may exchange data in circuit-switched, packet-switched, and/or other types of channels. Representative networks include telecommunications networks, local area networks, wide area networks and/or the Internet. For the purposes of the present discussion, the architecture and topology of the network (350) may be immaterial to the operation of the present disclosure unless explicitly explained herein.

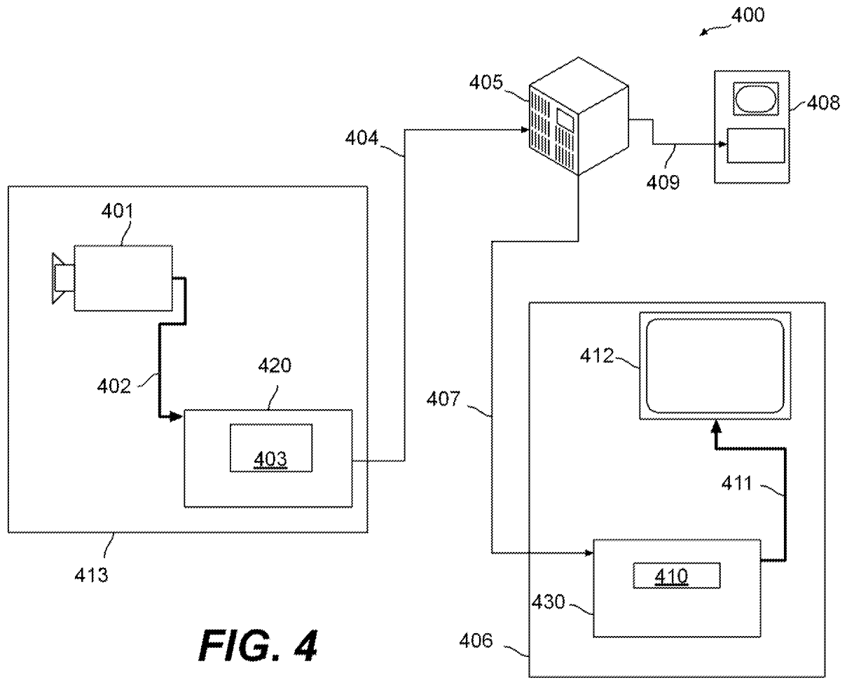

FIG. 4 illustrates, as an example for an application for the disclosed subject matter, a placement of a video encoder and a video decoder in a video streaming environment. The disclosed subject matter may be equally applicable to other video applications, including, for example, video conferencing, digital TV broadcasting, gaming, virtual reality, storage of compressed video on digital media including CD, DVD, memory stick and the like, and so on.

A video streaming system may include a video capture subsystem (413) that can include a video source (401), e.g., a digital camera, for creating a stream of video pictures or images (402) that are uncompressed. In an example, the stream of video pictures (402) includes samples that are recorded by a digital camera of the video source 401. The stream of video pictures (402), depicted as a bold line to emphasize a high data volume when compared to encoded video data (404) (or coded video bitstreams), can be processed by an electronic device (420) that includes a video encoder (403) coupled to the video source (401). The video encoder (403) can include hardware, software, or a combination thereof to enable or implement aspects of the disclosed subject matter as described in more detail below. The encoded video data (404) (or encoded video bitstream (404)), depicted as a thin line to emphasize a lower data volume when compared to the stream of uncompressed video pictures (402), can be stored on a streaming server (405) for future use or directly to downstream video devices (not shown). One or more streaming client subsystems, such as client subsystems (406) and (408) in FIG. 4 can access the streaming server (405) to retrieve copies (407) and (409) of the encoded video data (404). A client subsystem (406) can include a video decoder (410), for example, in an electronic device (430). The video decoder (410) decodes the incoming copy (407) of the encoded video data and creates an outgoing stream of video pictures (411) that are uncompressed and that can be rendered on a display (412) (e.g., a display screen) or other rendering devices (not depicted). The video decoder 410 may be configured to perform some or all of the various functions described in this disclosure. In some streaming systems, the encoded video data (404), (407), and (409) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC, and other video coding standards.

It is noted that the electronic devices (420) and (430) can include other components (not shown). For example, the electronic device (420) can include a video decoder (not shown) and the electronic device (430) can include a video encoder (not shown) as well.

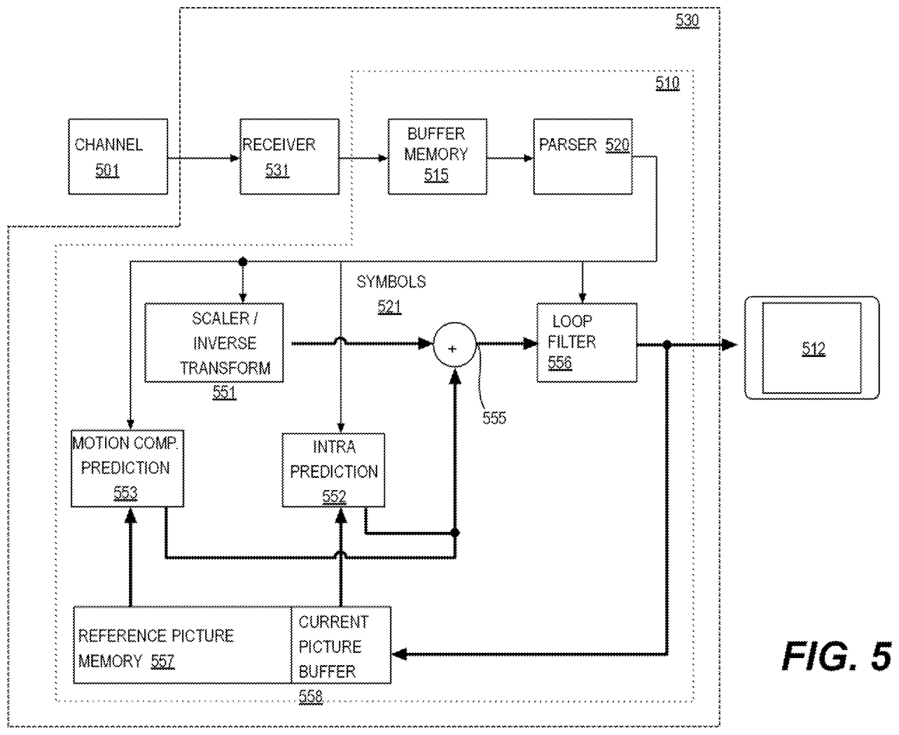

FIG. 5 shows a block diagram of a video decoder (510) according to any embodiment of the present disclosure below. The video decoder (510) can be included in an electronic device (530). The electronic device (530) can include a receiver (531) (e.g., receiving circuitry). The video decoder (510) can be used in place of the video decoder (410) in the example of FIG. 4.

The receiver (531) may receive one or more coded video sequences to be decoded by the video decoder (510). In the same or another embodiment, one coded video sequence may be decoded at a time, where the decoding of each coded video sequence is independent from other coded video sequences. Each video sequence may be associated with multiple video frames or images. The coded video sequence may be received from a channel (501), which may be a hardware/software link to a storage device which stores the encoded video data or a streaming source which transmits the encoded video data. The receiver (531) may receive the encoded video data with other data such as coded audio data and/or ancillary data streams, that may be forwarded to their respective processing circuitry (not depicted). The receiver (531) may separate the coded video sequence from the other data. To combat network jitter, a buffer memory (515) may be disposed in between the receiver (531) and an entropy decoder/parser (520) (“parser (520)” henceforth). In certain applications, the buffer memory (515) may be implemented as part of the video decoder (510). In other applications, it can be outside of and separate from the video decoder (510) (not depicted). In still other applications, there can be a buffer memory (not depicted) outside of the video decoder (510) for the purpose of, for example, combating network jitter, and there may be another additional buffer memory (515) inside the video decoder (510), for example to handle playback timing. When the receiver (531) is receiving data from a store/forward device of sufficient bandwidth and controllability, or from an isosynchronous network, the buffer memory (515) may not be needed, or can be small. For use on best-effort packet networks such as the Internet, the buffer memory (515) of sufficient size may be required, and its size can be comparatively large. Such buffer memory may be implemented with an adaptive size, and may at least partially be implemented in an operating system or similar elements (not depicted) outside of the video decoder (510).

The video decoder (510) may include the parser (520) to reconstruct symbols (521) from the coded video sequence. Categories of those symbols include information used to manage operation of the video decoder (510), and potentially information to control a rendering device such as display (512) (e.g., a display screen) that may or may not an integral part of the electronic device (530) but can be coupled to the electronic device (530), as is shown in FIG. 5. The control information for the rendering device(s) may be in the form of Supplemental Enhancement Information (SEI messages) or Video Usability Information (VUI) parameter set fragments (not depicted). The parser (520) may parse/entropy-decode the coded video sequence that is received by the parser (520). The entropy coding of the coded video sequence can be in accordance with a video coding technology or standard, and can follow various principles, including variable length coding, Huffman coding, arithmetic coding with or without context sensitivity, and so forth. The parser (520) may extract from the coded video sequence, a set of subgroup parameters for at least one of the subgroups of pixels in the video decoder, based upon at least one parameter corresponding to the subgroups. The subgroups can include Groups of Pictures (GOPs), pictures, tiles, slices, macroblocks, Coding Units (CUs), blocks, Transform Units (TUs), Prediction Units (PUs) and so forth. The parser (520) may also extract from the coded video sequence information such as transform coefficients (e.g., Fourier transform coefficients), quantizer parameter values, motion vectors, and so forth.

The parser (520) may perform an entropy decoding/parsing operation on the video sequence received from the buffer memory (515), so as to create symbols (521).

Reconstruction of the symbols (521) can involve multiple different processing or functional units depending on the type of the coded video picture or parts thereof (such as: inter and intra picture, inter and intra block), and other factors. The units that are involved and how they are involved may be controlled by the subgroup control information that was parsed from the coded video sequence by the parser (520). The flow of such subgroup control information between the parser (520) and the multiple processing or functional units below is not depicted for simplicity.

Beyond the functional blocks already mentioned, the video decoder (510) can be conceptually subdivided into a number of functional units as described below. In a practical implementation operating under commercial constraints, many of these functional units interact closely with each other and can, at least partly, be integrated with one another. However, for the purpose of describing the various functions of the disclosed subject matter with clarity, the conceptual subdivision into the functional units is adopted in the disclosure below.

A first unit may include the scaler/inverse transform unit (551). The scaler/inverse transform unit (551) may receive a quantized transform coefficient as well as control information, including information indicating which type of inverse transform to use, block size, quantization factor/parameters, quantization scaling matrices, and the lie as symbol(s) (521) from the parser (520). The scaler/inverse transform unit (551) can output blocks comprising sample values that can be input into aggregator (555).

In some cases, the output samples of the scaler/inverse transform (551) can pertain to an intra coded block, i.e., a block that does not use predictive information from previously reconstructed pictures, but can use predictive information from previously reconstructed parts of the current picture. Such predictive information can be provided by an intra picture prediction unit (552). In some cases, the intra picture prediction unit (552) may generate a block of the same size and shape of the block under reconstruction using surrounding block information that is already reconstructed and stored in the current picture buffer (558). The current picture buffer (558) buffers, for example, partly reconstructed current picture and/or fully reconstructed current picture. The aggregator (555), in some implementations, may add, on a per sample basis, the prediction information the intra prediction unit (552) has generated to the output sample information as provided by the scaler/inverse transform unit (551).

In other cases, the output samples of the scaler/inverse transform unit (551) can pertain to an inter coded, and potentially motion compensated block. In such a case, a motion compensation prediction unit (553) can access reference picture memory (557) to fetch samples used for inter-picture prediction. After motion compensating the fetched samples in accordance with the symbols (521) pertaining to the block, these samples can be added by the aggregator (555) to the output of the scaler/inverse transform unit (551) (output of unit 551 may be referred to as the residual samples or residual signal) so as to generate output sample information. The addresses within the reference picture memory (557) from where the motion compensation prediction unit (553) fetches prediction samples can be controlled by motion vectors, available to the motion compensation prediction unit (553) in the form of symbols (521) that can have, for example X, Y components (shift), and reference picture components (time). Motion compensation may also include interpolation of sample values as fetched from the reference picture memory (557) when sub-sample exact motion vectors are in use, and may also be associated with motion vector prediction mechanisms, and so forth.

The output samples of the aggregator (555) can be subject to various loop filtering techniques in the loop filter unit (556). Video compression technologies can include in-loop filter technologies that are controlled by parameters included in the coded video sequence (also referred to as coded video bitstream) and made available to the loop filter unit (556) as symbols (521) from the parser (520), but can also be responsive to meta-information obtained during the decoding of previous (in decoding order) parts of the coded picture or coded video sequence, as well as responsive to previously reconstructed and loop-filtered sample values. Several type of loop filters may be included as part of the loop filter unit 556 in various orders, as will be described in further detail below.

The output of the loop filter unit (556) can be a sample stream that can be output to the rendering device (512) as well as stored in the reference picture memory (557) for use in future inter-picture prediction.

Certain coded pictures, once fully reconstructed, can be used as reference pictures for future inter-picture prediction. For example, once a coded picture corresponding to a current picture is fully reconstructed and the coded picture has been identified as a reference picture (by, for example, the parser (520)), the current picture buffer (558) can become a part of the reference picture memory (557), and a fresh current picture buffer can be reallocated before commencing the reconstruction of the following coded picture.

The video decoder (510) may perform decoding operations according to a predetermined video compression technology adopted in a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools from all the tools available in the video compression technology or standard as the only tools available for use under that profile. To be standard-compliant, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In some example embodiments, the receiver (531) may receive additional (redundant) data with the encoded video. The additional data may be included as part of the coded video sequence(s). The additional data may be used by the video decoder (510) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

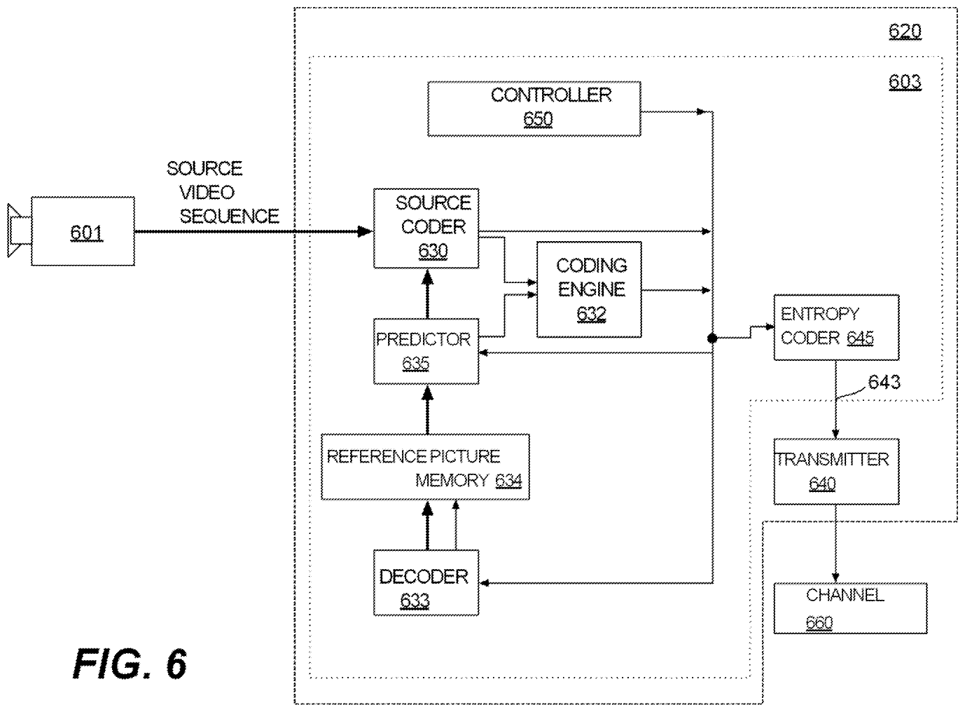

FIG. 6 shows a block diagram of a video encoder (603) according to an example embodiment of the present disclosure. The video encoder (603) may be included in an electronic device (620). The electronic device (620) may further include a transmitter (640) (e.g., transmitting circuitry). The video encoder (603) can be used in place of the video encoder (403) in the example of FIG. 4.

The video encoder (603) may receive video samples from a video source (601) (that is not part of the electronic device (620) in the example of FIG. 6) that may capture video image(s) to be coded by the video encoder (603). In another example, the video source (601) may be implemented as a portion of the electronic device (620).

The video source (601) may provide the source video sequence to be coded by the video encoder (603) in the form of a digital video sample stream that can be of any suitable bit depth (for example: 8 bit, 10 bit, 12 bit, . . . ), any colorspace (for example, BT.601 YCrCb, RGB, XYZ . . . ), and any suitable sampling structure (for example YCrCb 4:2:0, YCrCb 4:4:4). In a media serving system, the video source (601) may be a storage device capable of storing previously prepared video. In a videoconferencing system, the video source (601) may be a camera that captures local image information as a video sequence. Video data may be provided as a plurality of individual pictures or images that impart motion when viewed in sequence. The pictures themselves may be organized as a spatial array of pixels, wherein each pixel can comprise one or more samples depending on the sampling structure, color space, and the like being in use. A person having ordinary skill in the art can readily understand the relationship between pixels and samples. The description below focuses on samples.

According to some example embodiments, the video encoder (603) may code and compress the pictures of the source video sequence into a coded video sequence (643) in real time or under any other time constraints as required by the application. Enforcing appropriate coding speed constitutes one function of a controller (650). In some embodiments, the controller (650) may be functionally coupled to and control other functional units as described below. The coupling is not depicted for simplicity. Parameters set by the controller (650) can include rate control related parameters (picture skip, quantizer, lambda value of rate-distortion optimization techniques, . . . ), picture size, group of pictures (GOP) layout, maximum motion vector search range, and the like. The controller (650) can be configured to have other suitable functions that pertain to the video encoder (603) optimized for a certain system design.

In some example embodiments, the video encoder (603) may be configured to operate in a coding loop. As an oversimplified description, in an example, the coding loop can include a source coder (630) (e.g., responsible for creating symbols, such as a symbol stream, based on an input picture to be coded, and a reference picture(s)), and a (local) decoder (633) embedded in the video encoder (603). The decoder (633) reconstructs the symbols to create the sample data in a similar manner as a (remote) decoder would create even though the embedded decoder 633 process coded video steam by the source coder 630 without entropy coding (as any compression between symbols and coded video bitstream in entropy coding may be lossless in the video compression technologies considered in the disclosed subject matter). The reconstructed sample stream (sample data) is input to the reference picture memory (634). As the decoding of a symbol stream leads to bit-exact results independent of decoder location (local or remote), the content in the reference picture memory (634) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used to improve coding quality.

The operation of the “local” decoder (633) can be the same as of a “remote” decoder, such as the video decoder (510), which has already been described in detail above in conjunction with FIG. 5. Briefly referring also to FIG. 5, however, as symbols are available and encoding/decoding of symbols to a coded video sequence by an entropy coder (645) and the parser (520) can be lossless, the entropy decoding parts of the video decoder (510), including the buffer memory (515), and parser (520) may not be fully implemented in the local decoder (633) in the encoder.

An observation that can be made at this point is that any decoder technology except the parsing/entropy decoding that may only be present in a decoder also may necessarily need to be present, in substantially identical functional form, in a corresponding encoder. For this reason, the disclosed subject matter may at times focus on decoder operation, which allies to the decoding portion of the encoder. The description of encoder technologies can thus be abbreviated as they are the inverse of the comprehensively described decoder technologies. Only in certain areas or aspects a more detail description of the encoder is provided below.

During operation in some example implementations, the source coder (630) may perform motion compensated predictive coding, which codes an input picture predictively with reference to one or more previously coded picture from the video sequence that were designated as “reference pictures.” In this manner, the coding engine (632) codes differences (or residue) in the color channels between pixel blocks of an input picture and pixel blocks of reference picture(s) that may be selected as prediction reference(s) to the input picture. The term “residue” and its adjective form “residual” may be used interchangeably.

The local video decoder (633) may decode coded video data of pictures that may be designated as reference pictures, based on symbols created by the source coder (630). Operations of the coding engine (632) may advantageously be lossy processes. When the coded video data may be decoded at a video decoder (not shown in FIG. 6), the reconstructed video sequence typically may be a replica of the source video sequence with some errors. The local video decoder (633) replicates decoding processes that may be performed by the video decoder on reference pictures and may cause reconstructed reference pictures to be stored in the reference picture cache (634). In this manner, the video encoder (603) may store copies of reconstructed reference pictures locally that have common content as the reconstructed reference pictures that will be obtained by a far-end (remote) video decoder (absent transmission errors).

The predictor (635) may perform prediction searches for the coding engine (632). That is, for a new picture to be coded, the predictor (635) may search the reference picture memory (634) for sample data (as candidate reference pixel blocks) or certain metadata such as reference picture motion vectors, block shapes, and so on, that may serve as an appropriate prediction reference for the new pictures. The predictor (635) may operate on a sample block-by-pixel block basis to find appropriate prediction references. In some cases, as determined by search results obtained by the predictor (635), an input picture may have prediction references drawn from multiple reference pictures stored in the reference picture memory (634).

The controller (650) may manage coding operations of the source coder (630), including, for example, setting of parameters and subgroup parameters used for encoding the video data.

Output of all aforementioned functional units may be subjected to entropy coding in the entropy coder (645). The entropy coder (645) translates the symbols as generated by the various functional units into a coded video sequence, by lossless compression of the symbols according to technologies such as Huffman coding, variable length coding, arithmetic coding, and so forth.

The transmitter (640) may buffer the coded video sequence(s) as created by the entropy coder (645) to prepare for transmission via a communication channel (660), which may be a hardware/software link to a storage device which would store the encoded video data. The transmitter (640) may merge coded video data from the video coder (603) with other data to be transmitted, for example, coded audio data and/or ancillary data streams (sources not shown).

The controller (650) may manage operation of the video encoder (603). During coding, the controller (650) may assign to each coded picture a certain coded picture type, which may affect the coding techniques that may be applied to the respective picture. For example, pictures often may be assigned as one of the following picture types:

An Intra Picture (I picture) may be one that may be coded and decoded without using any other picture in the sequence as a source of prediction. Some video codecs allow for different types of intra pictures, including, for example Independent Decoder Refresh (“IDR”) Pictures. A person having ordinary skill in the art is aware of those variants of I pictures and their respective applications and features.

A predictive picture (P picture) may be one that may be coded and decoded using intra prediction or inter prediction using at most one motion vector and reference index to predict the sample values of each block.

A bi-directionally predictive picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample coding blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures. The source pictures or the intermediate processed pictures may be subdivided into other types of blocks for other purposes. The division of coding blocks and the other types of blocks may or may not follow the same manner, as described in further detail below.

The video encoder (603) may perform coding operations according to a predetermined video coding technology or standard, such as ITU-T Rec. H.265. In its operation, the video encoder (603) may perform various compression operations, including predictive coding operations that exploit temporal and spatial redundancies in the input video sequence. The coded video data may accordingly conform to a syntax specified by the video coding technology or standard being used.

In some example embodiments, the transmitter (640) may transmit additional data with the encoded video. The source coder (630) may include such data as part of the coded video sequence. The additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) utilizes spatial correlation in a given picture, and inter-picture prediction utilizes temporal or other correlation between the pictures. For example, a specific picture under encoding/decoding, which is referred to as a current picture, may be partitioned into blocks. A block in the current picture, when similar to a reference block in a previously coded and still buffered reference picture in the video, may be coded by a vector that is referred to as a motion vector. The motion vector points to the reference block in the reference picture, and can have a third dimension identifying the reference picture, in case multiple reference pictures are in use.

In some example embodiments, a bi-prediction technique can be used for inter-picture prediction. According to such bi-prediction technique, two reference pictures, such as a first reference picture and a second reference picture that both proceed the current picture in the video in decoding order (but may be in the past or future, respectively, in display order) are used. A block in the current picture can be coded by a first motion vector that points to a first reference block in the first reference picture, and a second motion vector that points to a second reference block in the second reference picture. The block can be jointly predicted by a combination of the first reference block and the second reference block.

Further, a merge mode technique may be used in the inter-picture prediction to improve coding efficiency.

According to some example embodiments of the disclosure, predictions, such as inter-picture predictions and intra-picture predictions are performed in the unit of blocks. For example, a picture in a sequence of video pictures is partitioned into coding tree units (CTU) for compression, the CTUs in a picture may have the same size, such as 128×128 pixels, 64×64 pixels, 32×32 pixels, or 16×16 pixels. In general, a CTU may include three parallel coding tree blocks (CTBs): one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels. Each of the one or more of the 32×32 block may be further split into 4 CUs of 16×16 pixels. In some example embodiments, each CU may be analyzed during encoding to determine a prediction type for the CU among various prediction types such as an inter prediction type or an intra prediction type. The CU may be split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. The split of a CU into PU (or PBs of different color channels) may be performed in various spatial pattern. A luma or chroma PB, for example, may include a matrix of values (e.g., luma values) for samples, such as 8×8 pixels, 16×16 pixels, 8×16 pixels, 16×8 samples, and the like.

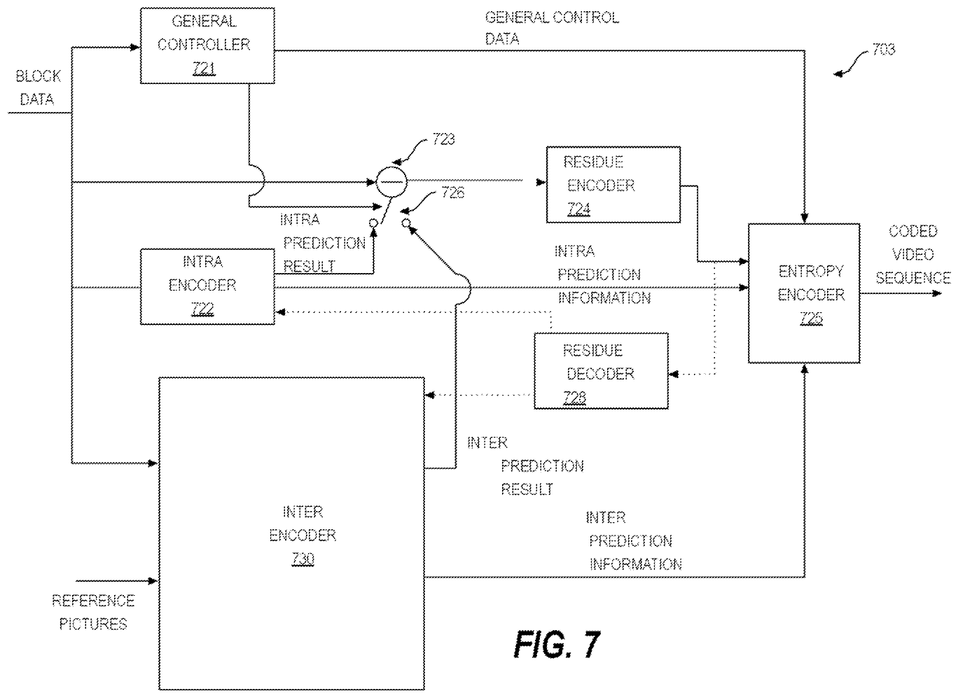

FIG. 7 shows a diagram of a video encoder (703) according to another example embodiment of the disclosure. The video encoder (703) is configured to receive a processing block (e.g., a prediction block) of sample values within a current video picture in a sequence of video pictures, and encode the processing block into a coded picture that is part of a coded video sequence. The example video encoder (703) may be used in place of the video encoder (403) in the FIG. 4 example.

For example, the video encoder (703) receives a matrix of sample values for a processing block, such as a prediction block of 8×8 samples, and the like. The video encoder (703) then determines whether the processing block is best coded using intra mode, inter mode, or bi-prediction mode using, for example, rate-distortion optimization (RDO). When the processing block is determined to be coded in intra mode, the video encoder (703) may use an intra prediction technique to encode the processing block into the coded picture; and when the processing block is determined to be coded in inter mode or bi-prediction mode, the video encoder (703) may use an inter prediction or bi-prediction technique, respectively, to encode the processing block into the coded picture. In some example embodiments, a merge mode may be used as a submode of the inter picture prediction where the motion vector is derived from one or more motion vector predictors without the benefit of a coded motion vector component outside the predictors. In some other example embodiments, a motion vector component applicable to the subject block may be present. Accordingly, the video encoder (703) may include components not explicitly shown in FIG. 7, such as a mode decision module, to determine the perdition mode of the processing blocks.

In the example of FIG. 7, the video encoder (703) includes an inter encoder (730), an intra encoder (722), a residue calculator (723), a switch (726), a residue encoder (724), a general controller (721), and an entropy encoder (725) coupled together as shown in the example arrangement in FIG. 7.

The inter encoder (730) is configured to receive the samples of the current block (e.g., a processing block), compare the block to one or more reference blocks in reference pictures (e.g., blocks in previous pictures and later pictures in display order), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information using the decoding unit 633 embedded in the example encoder 620 of FIG. 6 (shown as residual decoder 728 of FIG. 7, as described in further detail below).

The intra encoder (722) is configured to receive the samples of the current block (e.g., a processing block), compare the block to blocks already coded in the same picture, and generate quantized coefficients after transform, and in some cases also to generate intra prediction information (e.g., an intra prediction direction information according to one or more intra encoding techniques). The intra encoder (722) may calculates intra prediction results (e.g., predicted block) based on the intra prediction information and reference blocks in the same picture.

The general controller (721) may be configured to determine general control data and control other components of the video encoder (703) based on the general control data. In an example, the general controller (721) determines the prediction mode of the block, and provides a control signal to the switch (726) based on the prediction mode. For example, when the prediction mode is the intra mode, the general controller (721) controls the switch (726) to select the intra mode result for use by the residue calculator (723), and controls the entropy encoder (725) to select the intra prediction information and include the intra prediction information in the bitstream; and when the predication mode for the block is the inter mode, the general controller (721) controls the switch (726) to select the inter prediction result for use by the residue calculator (723), and controls the entropy encoder (725) to select the inter prediction information and include the inter prediction information in the bitstream.

The residue calculator (723) may be configured to calculate a difference (residue data) between the received block and prediction results for the block selected from the intra encoder (722) or the inter encoder (730). The residue encoder (724) may be configured to encode the residue data to generate transform coefficients. For example, the residue encoder (724) may be configured to convert the residue data from a spatial domain to a frequency domain to generate the transform coefficients. The transform coefficients are then subject to quantization processing to obtain quantized transform coefficients. In various example embodiments, the video encoder (703) also includes a residual decoder (728). The residual decoder (728) is configured to perform inverse-transform, and generate the decoded residue data. The decoded residue data can be suitably used by the intra encoder (722) and the inter encoder (730). For example, the inter encoder (730) can generate decoded blocks based on the decoded residue data and inter prediction information, and the intra encoder (722) can generate decoded blocks based on the decoded residue data and the intra prediction information. The decoded blocks are suitably processed to generate decoded pictures and the decoded pictures can be buffered in a memory circuit (not shown) and used as reference pictures.

The entropy encoder (725) may be configured to format the bitstream to include the encoded block and perform entropy coding. The entropy encoder (725) is configured to include in the bitstream various information. For example, the entropy encoder (725) may be configured to include the general control data, the selected prediction information (e.g., intra prediction information or inter prediction information), the residue information, and other suitable information in the bitstream. When coding a block in the merge submode of either inter mode or bi-prediction mode, there may be no residue information.

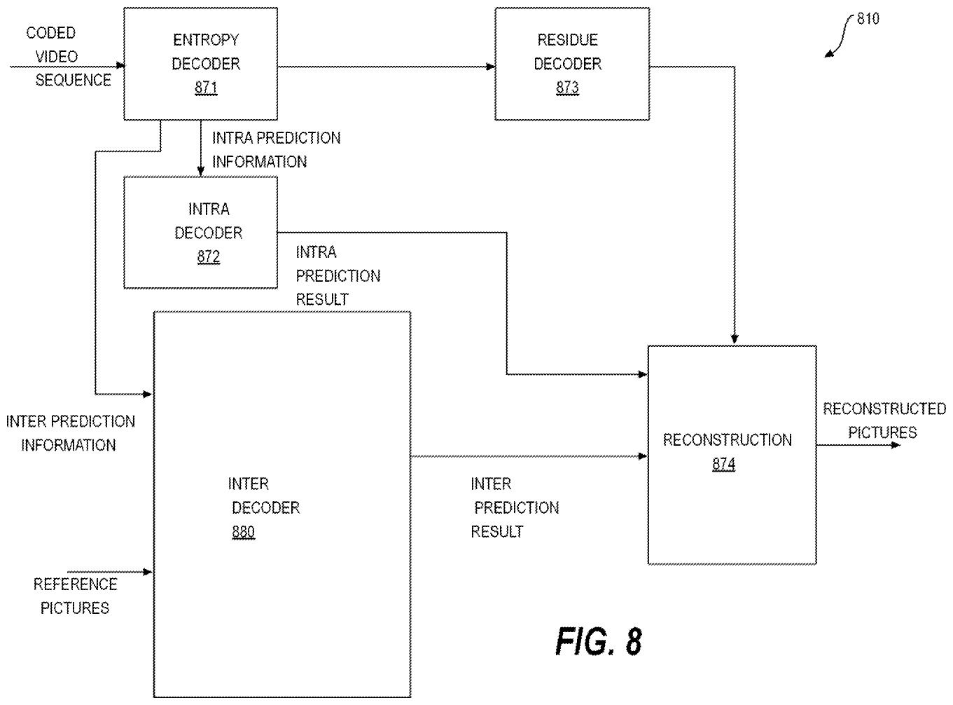

FIG. 8 shows a diagram of an example video decoder (810) according to another embodiment of the disclosure. The video decoder (810) is configured to receive coded pictures that are part of a coded video sequence, and decode the coded pictures to generate reconstructed pictures. In an example, the video decoder (810) may be used in place of the video decoder (410) in the example of FIG. 4.

In the example of FIG. 8, the video decoder (810) includes an entropy decoder (871), an inter decoder (880), a residual decoder (873), a reconstruction module (874), and an intra decoder (872) coupled together as shown in the example arrangement of FIG. 8.

The entropy decoder (871) can be configured to reconstruct, from the coded picture, certain symbols that represent the syntax elements of which the coded picture is made up. Such symbols can include, for example, the mode in which a block is coded (e.g., intra mode, inter mode, bi-predicted mode, merge submode or another submode), prediction information (e.g., intra prediction information or inter prediction information) that can identify certain sample or metadata used for prediction by the intra decoder (872) or the inter decoder (880), residual information in the form of, for example, quantized transform coefficients, and the like. In an example, when the prediction mode is the inter or bi-predicted mode, the inter prediction information is provided to the inter decoder (880); and when the prediction type is the intra prediction type, the intra prediction information is provided to the intra decoder (872). The residual information can be subject to inverse quantization and is provided to the residual decoder (873).

The inter decoder (880) may be configured to receive the inter prediction information, and generate inter prediction results based on the inter prediction information.

The intra decoder (872) may be configured to receive the intra prediction information, and generate prediction results based on the intra prediction information.

The residual decoder (873) may be configured to perform inverse quantization to extract de-quantized transform coefficients, and process the de-quantized transform coefficients to convert the residual from the frequency domain to the spatial domain. The residual decoder (873) may also utilize certain control information (to include the Quantizer Parameter (QP)) which may be provided by the entropy decoder (871) (data path not depicted as this may be low data volume control information only).

The reconstruction module (874) may be configured to combine, in the spatial domain, the residual as output by the residual decoder (873) and the prediction results (as output by the inter or intra prediction modules as the case may be) to form a reconstructed block forming part of the reconstructed picture as part of the reconstructed video. It is noted that other suitable operations, such as a deblocking operation and the like, may also be performed to improve the visual quality.

It is noted that the video encoders (403), (603), and (703), and the video decoders (410), (510), and (810) can be implemented using any suitable technique. In some example embodiments, the video encoders (403), (603), and (703), and the video decoders (410), (510), and (810) can be implemented using one or more integrated circuits. In another embodiment, the video encoders (403), (603), and (603), and the video decoders (410), (510), and (810) can be implemented using one or more processors that execute software instructions.

Turning to block partitioning for coding and decoding, general partitioning may start from a base block and may follow a predefined ruleset, particular patterns, partition trees, or any partition structure or scheme. The partitioning may be hierarchical and recursive. After dividing or partitioning a base block following any of the example partitioning procedures or other procedures described below, or the combination thereof, a final set of partitions or coding blocks may be obtained. Each of these partitions may be at one of various partitioning levels in the partitioning hierarchy, and may be of various shapes. Each of the partitions may be referred to as a coding block (CB). For the various example partitioning implementations described further below, each resulting CB may be of any of the allowed sizes and partitioning levels. Such partitions are referred to as coding blocks because they may form units for which some basic coding/decoding decisions may be made and coding/decoding parameters may be optimized, determined, and signaled in an encoded video bitstream. The highest or deepest level in the final partitions represents the depth of the coding block partitioning structure of tree. A coding block may be a luma coding block or a chroma coding block. The CB tree structure of each color may be referred to as coding block tree (CBT).

The coding blocks of all color channels may collectively be referred to as a coding unit (CU). The hierarchical structure of for all color channels may be collectively referred to as coding tree unit (CTU). The partitioning patterns or structures for the various color channels in in a CTU may or may not be the same.

In some implementations, partition tree schemes or structures used for the luma and chroma channels may not need to be the same. In other words, luma and chroma channels may have separate coding tree structures or patterns. Further, whether the luma and chroma channels use the same or different coding partition tree structures and the actual coding partition tree structures to be used may depend on whether the slice being coded is a P, B, or I slice. For example, For an I slice, the chroma channels and luma channel may have separate coding partition tree structures or coding partition tree structure modes, whereas for a P or B slice, the luma and chroma channels may share a same coding partition tree scheme. When separate coding partition tree structures or modes are applied, a luma channel may be partitioned into CBs by one coding partition tree structure, and a chroma channel may be partitioned into chroma CBs by another coding partition tree structure.

Turning back to FIG. 2, each frame in a same sequence may have some common characteristics or properties. For example, each frame in a sequence may share a same profile, a same chroma format, a same level, and the like. Therefore, for decoding purpose, all frames in a sequence may share a parameter set at sequence level, and such parameter set is referred to as a sequence parameter set (SPS, or sequence level parameter set). On the decoder side, the decoder may refer to the SPS for various decoding tasks, including initializing decoding parameters, parsing the bitstream, performing memory management, and so on.

In example implementations, the SPS may include at least following parameters:
a profile;
a level value;
a tier value;
a chroma format;
a bit-depth;
a picture width;
a picture height;
an entropy coding mode; or
a transform mode.

The SPS set may apply to various video technologies and standards, including and not limited to: HEVC, VVC, AV1, AV2, AVS, AVS2, AVS3, and future generation video standards.

During decoding process, it is critical for the decoder to use the right SPS to decode a sequence of frames, otherwise the sequence may not be decoded correctly. Various performance overheads may be introduced by the SPS. For example, transmission of the SPS in the bitstream takes transmission bandwidth. On the decoder side, effort is needed to parse the SPS from raw data bits, and to store/activate the parsed SPS for subsequent use.

In this disclosure, various embodiments aim at improving SPS implementations are described. In one aspect, some embodiments may improve SPS signaling efficiency. For example, the SPS is only signaled on a as-needed basis, and currently activated SPS (also known as serving SPS) may be re-used for following video samples in a same sequence. In another aspect, some embodiments may improve flexibility on SPS determination. For example, SPS may be made available (e.g., by encapsulating the SPS in the bitstream) to the decoder, yet the decoder may determine whether an SPS update is needed and has the flexibility to either ignore the signaled SPS or update the SPS base on the signaled SPS. In another aspect, for a same video source transmitted in different sessions, the encoder may choose to signal different SPSs for a same sequence based on, for example, a transmission condition, a Quality of Service agreement, etc. In yet another aspect, in the duration of a video streaming, SPS applied to video sequences may be dynamically updated, for example, to achieve better compression rate and/or better video quality, to adapt to various types of decoders and/or various transmission conditions, etc.

In some example implementations, a serving SPS is the specific SPS used for decoding the current video frame. In some scenarios, the serving SPS may be the same as the SPS used for decoding the previous video frame of the current video frame, for example, if the previous video frame and the current video frame are in a same sequence. In this case, the decoder may re-use the previous used SPS directly (e.g., the serving SPS is stored in memory already). In some scenarios, the serving SPS may be different from the SPS used for decoding the previous video frame, for example, if the previous video frame and the current video frame are in a different sequence. In this case, the decoder may obtain the serving SPS by, for example, parsing SPS related syntax in the video bitstream.

In some example implementations, referring to FIG. 2, in each video sample, a flag is signaled to indicate whether the current video sample encapsulates/carries an SPS. For example, in video sample 1, the flag may be signaled as true to indicate there is an SPS 1 carried in video sample 1. Whereas in video sample 2, the flag may be signaled as false to indicate that there is no SPS carried in video sample 2. If a video sample is indicated as carrying an SPS, location information, such as a length of the SPS may be further signaled. The starting position of the SPS in the video sample may be a fixed or predefined position, or may be signaled. The staring position may include an offset from a certain reference point, such as the start of the video frame, or the start of the flag. In these implementations, SPS may be signaled on a as as-needed basis, for example, when the SPS needs to be updated for the current video sample, such as video sample 1. This may happen when a new sequence starts. The decoder, when processing video sample 1, may need to parse the bitstream to retrieve the encapsulated SPS, activate the retrieved SPS and use it to decode the video sequence in video sample 1. However, for video sample 2, the SPS is not changed from the SPS signaled in video sample 1, so the decoder may reuse SPS 1, which is already activated, for decoding video sample 2. An activated SPS for decoding video sample may be referred to as a serving SPS.

In some example implementations, regardless whether the SPS is updated or not, it will be signaled in each video sample. Referring to FIG. 2, SPS 2 is signaled in video sample n, even the same SPS 2 is signaled in video sample n−1. A flag may still be signaled to indicate the SPS update status. If the flag indicates that the SPS is updated, then the decoder will need to parse the bitstream to retrieve the updated SPS. Otherwise, the flag may indicate that the SPS is not updated from the previous video sample, and the decoder may have different options. In one option, the decoder may skip parsing the content of the SPS carried in the current video sample, and directly use the previous SPS (used for the previous video sample and stored for later use) which is already parsed. This option is useful when the video streaming is played sequentially (i.e., the frames are displayed following timeline sequence), as the SPS parsing cost is saved. In another option, even the flag indicates that there is no SPS update, the decoder may nevertheless need to parse the content of the SPS carried in the current video sample, and use the newly parsed/retrieved SPS for decoding the current video sample. This option is useful when the current video sample is a starting point of a random access play, as the previously used SPS in this case may be the SPS for a random video sample and is no longer valid for the current video sample, so a force refresh on the SPS may be desirable. In these implementations, the SPS and the next frame to be displayed will be encapsulated into the same video sample, so the SPS is always available to the decoder. The SPS location information may be signaled similarly as in earlier implementations.

In the above example implementations, whether the video streaming being an ordered play (following the frame timeline) or a random access play is made transparent to the server/encoder, which encapsulates the SPS in each video sample regardless. The logic for selecting the SPS only needs to be implemented on the terminal/decoder side.

In some example implementations, an SPS update flag may be signaled to indicate the SPS update status, and the SPS will be signaled in a video sample only if the SPS is updated to be different from the SPS used for the previous video sample. If the SPS update flag indicates that the SPS is updated, then the decoder may parse the bitstream to obtain the updated SPS, store/conserve the updated SPS in, for example, a local or on-chip memory, and keep using the updated SPS for subsequent video samples until the SPS is updated again as indicated by the SPS update flag. On the other hand, if the SPS update flag indicates that there is no SPS update, the decoder may use the previous SPS that has been stored, without any SPS parsing and processing effort. Note that if the SPS update flag indicates that the SPS is updated, then location information, such as a length of the SPS may be further signaled. The starting position of the SPS in the video sample may be a fixed or predefined position, or may be signaled. The staring position may include an offset from a certain reference point, such as the start of the video frame, or the location of the SPS update flag.

In some example implementations, a syntax element may be signaled for every video sample, to indicate the length of the SPS that is associated with the video sample. When this length is equal to 0, it implicitly indicates that the current video sample does not carry an SPS and therefore, no subsequent SPS content needs to be parsed. In this case, the decoder will use the previous SPS (for decoding the previous video sample) for proper decoding. When this length is not equal to 0, it indicates that the SPS is signaled, for example, immediately following the length information field, or starting from a predefined position. The decoder will parse and use the SPS signaled/encapsulated in the current video sample.

In some example implementation, from the server side, the server or the encoder may determine a list of SPSs that will be used in the video streaming session, and signal the list of SPSs to the terminal (decoder) when the video streaming session starts, with each SPS in the list of SPSs being identifiable by an SPS id (identifier). Then in each video frame, an SPS id may be signaled, to notify the decoder which SPS should be selected from the list of SPSs and applied when decoding the video frame. The detailed SPS content is no longer need to be signaled. Therefore, SPS signaling overhead may be reduced and SPS parsing effort on the decoder is also eliminated. Additionally, a special SPS id, such as 0, a negative number, a maximum number supported by the SPS id field (such as 0×ff, is the SPS id is one byte long) may be used to indicate that there is no SPS update so the decoder may use the previous SPS directly. These implementations may be particularly useful for random access scenarios.

In some example implementation, rather than the server/encoder signaling the list of SPSs as described in the implementations above, the terminal/decoder receiving the video streaming may collect and maintain the list of SPSs. For example, an SPS is signaled in the video sample, and the SPS may include an id. The decoder may maintain the list of SPSs by adding to the list any new SPS (indicated by its id) received. For each video sample, the decoder may first perform a lookup to check if the SPS as indicated by the SPS id (e.g., carried in the video sample) already exists in the list of SPSs. The parsing of the SPS content from the bitstream may be skipped if the decoder is able to find the particular SPS from the list of SPS. In one implementation, the list of SPSs may be implemented via a circular buffer, to avoid using excessive memory.

In some example implementation, if the current video sample includes a random video sequence resulted from a random access request, the encoder may make a determination whether the SPS for the random video sequence is the same as the SPS which was used for the last video sample fed to the receiving terminal (e.g., the decoder). For example, as shown in FIG. 2, if the last played sequence is in video sample 1, and the next sequence is a random sequence, which is in video sample n (i.e., video jumps from video sample 1 to video sample n), as there is an SPS update (from SPS 1 to SPS 2), the bitstream will signal an SPS update flag indicating the SPS update. The decoder will retrieve the updated SPS correspondingly. However, when jumping to video sample n, in case that the last played sequence also uses SPS 2, then the SPS update flag will indicate that there is no update on SPS, and SPS is not signaled in video sample n. Therefore, even the current video sample is a random access starting point, the decoder may still reuse the previous SPS.

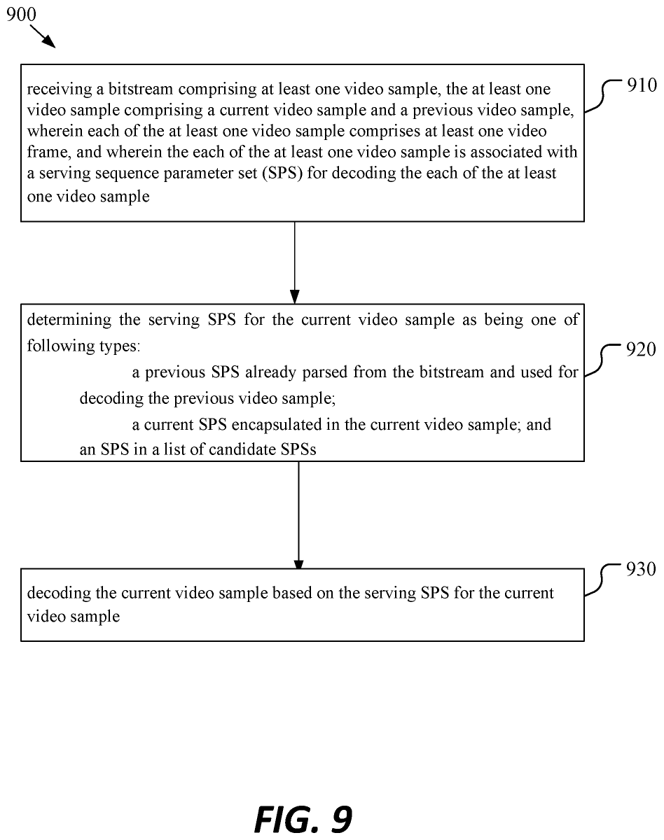

FIG. 9 shows an exemplary method 900 for processing video data. The method may include a portion or all of the following step: step 910, receiving a bitstream comprising at least one video sample, the at least one video sample comprising a current video sample and a previous video sample, wherein each of the at least one video sample comprises at least one video frame, and wherein the each of the at least one video sample is associated with a serving sequence parameter set (SPS) for decoding the each of the at least one video sample; step 920, determining the serving SPS for the current video sample as being one of:
a previous SPS already parsed from the bitstream and used for decoding the previous video sample;
a current SPS encapsulated in the current video sample; and
an SPS in a list of candidate SPSs;
and step 930, decoding the current video sample based on the serving SPS for the current video sample.

In the embodiments and implementation of this disclosure, any steps and/or operations may be combined or arranged in any amount or order, as desired. Two or more of the steps and/or operations may be performed in parallel. Embodiments and implementations in the disclosure may be used separately or combined in any order. Further, each of the methods (or embodiments), an encoder, and a decoder may be implemented by processing circuitry (e.g., one or more processors or one or more integrated circuits). In one example, the one or more processors execute a program that is stored in a non-transitory computer-readable medium.

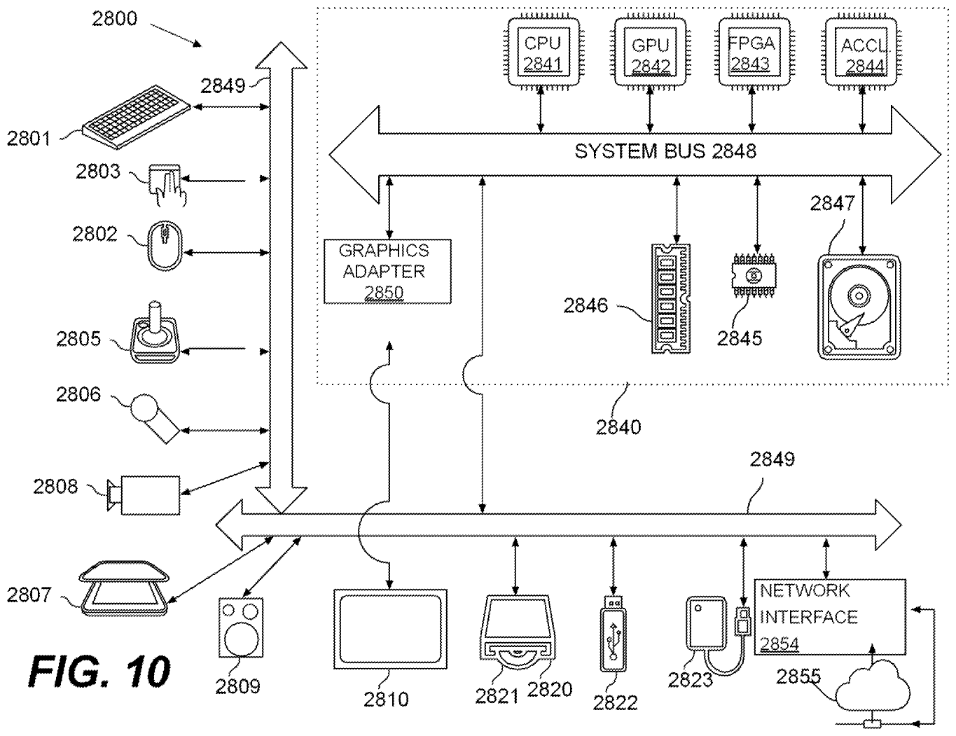

The techniques described above, can be implemented as computer software using computer-readable instructions and physically stored in one or more computer-readable media. For example, FIG. 10 shows a computer system (2800) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (2800) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (2800).

Computer system (2800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2801), mouse (2802), trackpad (2803), touch screen (2810), data-glove (not shown), joystick (2805), microphone (2806), scanner (2807), camera (2808).

Computer system (2800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2810), data-glove (not shown), or joystick (2805), but there can also be tactile feedback devices that do not serve as input devices), audio output devices (such as: speakers (2809), headphones (not depicted)), visual output devices (such as screens (2810) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (2800) can also include human accessible storage devices and their associated media such as optical media including CD/DVD ROM/RW (2820) with CD/DVD or the like media (2821), thumb-drive (2822), removable hard drive or solid state drive (2823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2800) can also include an interface (2854) to one or more communication networks (2855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN bus, and so forth. Certain networks commonly require external network interface adapters that attached to certain general-purpose data ports or peripheral buses (2849) (such as, for example USB ports of the computer system (2800)); others are commonly integrated into the core of the computer system (2800) by attachment to a system bus as described below (for example Ethernet interface into a PC computer system or cellular network interface into a smartphone computer system). Using any of these networks, computer system (2800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2840) of the computer system (2800).

The core (2840) can include one or more Central Processing Units (CPU) (2841), Graphics Processing Units (GPU) (2842), specialized programmable processing units in the form of Field Programmable Gate Areas (FPGA) (2843), hardware accelerators for certain tasks (2844), graphics adapters (2850), and so forth. These devices, along with Read-only memory (ROM) (2845), Random-access memory (2846), internal mass storage such as internal non-user accessible hard drives, SSDs, and the like (2847), may be connected through a system bus (2848). In some computer systems, the system bus (2848) can be accessible in the form of one or more physical plugs to enable extensions by additional CPUs, GPU, and the like. The peripheral devices can be attached either directly to the core's system bus (2848), or through a peripheral bus (2849). In an example, the screen (2810) can be connected to the graphics adapter (2850). Architectures for a peripheral bus include PCI, USB, and the like.

CPUs (2841), GPUs (2842), FPGAs (2843), and accelerators (2844) can execute certain instructions that, in combination, can make up the aforementioned computer code. That computer code can be stored in ROM (2845) or RAM (2846). Transitional data can also be stored in RAM (2846), whereas permanent data can be stored for example, in the internal mass storage (2847). Fast storage and retrieve to any of the memory devices can be enabled through the use of cache memory, that can be closely associated with one or more CPU (2841), GPU (2842), mass storage (2847), ROM (2845), RAM (2846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As a non-limiting example, the computer system having architecture (2800), and specifically the core (2840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2840) that are of non-transitory nature, such as core-internal mass storage (2847) or ROM (2845). The software implementing various embodiments of the present disclosure can be stored in such devices and executed by core (2840). A computer-readable medium can include one or more memory devices or chips, according to particular needs. The software can cause the core (2840) and specifically the processors therein (including CPU, GPU, FPGA, and the like) to execute particular processes or particular parts of particular processes described herein, including defining data structures stored in RAM (2846) and modifying such data structures according to the processes defined by the software. In addition or as an alternative, the computer system can provide functionality as a result of logic hardwired or otherwise embodied in a circuit (for example: accelerator (2844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure uses visual media as examples, the proposed embodiments may, however, be used in other similar scenarios, such as audio, or other type of media content.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.
Appendix A: Acronyms
IBC: Intra-Block Copy
IntraBC: Intra-Block Copy
JEM: joint exploration model
VVC: versatile video coding
BMS: benchmark set
MV: Motion Vector
HEVC: High Efficiency Video Coding
SEI: Supplementary Enhancement Information
VUI: Video Usability Information
GOPs: Groups of Pictures
TUs: Transform Units,
PUs: Prediction Units
CTUs: Coding Tree Units
CTBs: Coding Tree Blocks
PBs: Prediction Blocks
HRD: Hypothetical Reference Decoder
SNR: Signal Noise Ratio
CPUs: Central Processing Units
GPUs: Graphics Processing Units
CRT: Cathode Ray Tube
LCD: Liquid-Crystal Display
OLED: Organic Light-Emitting Diode
CD: Compact Disc
DVD: Digital Video Disc
ROM: Read-Only Memory
RAM: Random Access Memory
ASIC: Application-Specific Integrated Circuit
PLD: Programmable Logic Device
LAN: Local Area Network
GSM: Global System for Mobile communications
LTE: Long-Term Evolution
CANBus: Controller Area Network Bus
USB: Universal Serial Bus
PCI: Peripheral Component Interconnect
FPGA: Field Programmable Gate Areas
SSD: solid-state drive
IC: Integrated Circuit
HDR: high dynamic range
SDR: standard dynamic range
JVET: Joint Video Exploration Team
MPM: most probable mode
WAIP: Wide-Angle Intra Prediction
CU: Coding Unit
PU: Prediction Unit
TU: Transform Unit
CTU: Coding Tree Unit
PDPC: Position Dependent Prediction Combination
ISP: Intra Sub-Partitions
SPS: Sequence Parameter Setting
PPS: Picture Parameter Set
APS: Adaptation Parameter Set
VPS: Video Parameter Set
DPS: Decoding Parameter Set
ALF: Adaptive Loop Filter
SAO: Sample Adaptive Offset
CC-ALF: Cross-Component Adaptive Loop Filter
CDEF: Constrained Directional Enhancement Filter
CCSO: Cross-Component Sample Offset
LSO: Local Sample Offset
LR: Loop Restoration Filter
AV1: AOMedia Video 1
AV2: AOMedia Video 2
AVS: Audio and Video Coding Standard
AVS2: The Second Generation AVS Standard
AVS3: The Third Generation AVS Standard
DASH: Dynamic Adaptive Streaming over HTTP
ISO BMFF: ISO Base Media File Format
VOD: Video on Demand
RPS: Reference Picture Set

What is claimed is:

1. A method for video processing, the method comprising:
receiving a bitstream comprising at least one video sample, the at least one video sample comprising a current video sample and a previous video sample, wherein each of the at least one video sample comprises at least one video frame, and wherein the each of the at least one video sample is associated with a serving sequence parameter set (SPS) for decoding the each of the at least one video sample;
determining the serving SPS for the current video sample as being one of following types:
a previous SPS already parsed from the bitstream and used for decoding the previous video sample;
a current SPS encapsulated in the current video sample; and
an SPS in a list of candidate SPSs; and
decoding the current video sample based on the serving SPS for the current video sample and the determined type of the serving SPS.

2. The method of claim 1, wherein the SPS comprises at least one of following parameters:
a profile;
a level value;
a tier value;
a chroma format;
a bit-depth;
a picture width;
a picture height;
an entropy coding mode; and
a transform mode.

3. The method of claim 1, wherein determining the serving SPS for the current video sample comprises:
extracting from the bitstream, an SPS existence flag indicating whether the current video sample encapsulates the current SPS; and
in response to the SPS existence flag indicating that the current video sample encapsulates the current SPS:
extracting from the bitstream, a location information of the current SPS;
parsing the bitstream based on the location information, to obtain the current SPS; and
determining the current SPS as the serving SPS for the current video sample.

4. The method of claim 3, further comprising: in response to the SPS existence flag indicating that the current video sample does not encapsulate the current SPS, determining the previous SPS as the serving SPS for the current video sample.

5. The method of claim 1, wherein:
the each of the at least one video sample encapsulates an SPS;
the SPS encapsulated in the current video sample is the current SPS; and
determining the serving SPS for the current video sample comprises:
extracting from the bitstream, a SPS update status flag indicating whether the serving SPS is updated from the previous SPS used for decoding the previous video sample;
in response to the SPS update status flag indicating the serving SPS being updated from the previous SPS, determining the current SPS as the serving SPS; and
in response to the SPS update status flag indicating the serving SPS not being updated from the previous SPS, ignoring and skipping parsing the current SPS in the current video sample, and determining the previous SPS as the serving SPS for the current video sample.

6. The method of claim 1, wherein the current SPS is encapsulated in the current video sample in response to the current video sample being a start point of a random access request.

7. The method of claim 6, wherein determining the serving SPS for the current video sample comprises:
in response to the current video sample being a start point of a random access request, determining the current SPS as the serving SPS for the current video sample.

8. The method of claim 1, further comprising:
storing the serving SPS for the current video sample;
receiving a next video sample following the current video sample from the bitstream;
determining that the serving SPS for the next video sample is not updated from the serving SPS for the current video sample; and
decoding the next video sample based on the serving SPS for the current video sample.

9. The method of claim 1, wherein:
before receiving the bitstream comprising the at least one video sample, the method further comprises receiving from the bitstream, the list of candidate SPSs; and
determining the serving SPS for the current video sample comprises:
extracting from the bitstream, an SPS identifier associated with the current video sample and identifying an SPS in the list of candidate SPSs; and
determining the SPS in the list of candidate SPSs identified by the SPS identifier as the serving SPS for the current video sample.

10. The method of claim 1, wherein:
the current video sample encapsulates the current SPS;
the method further comprises determining whether that the current SPS is in the list of candidate SPSs; and
determining the serving SPS for the current video sample comprises:
in response to the current SPS not being in the list of candidate SPSs:
parsing the current video sample to obtain the current SPS;
adding the current SPS to the list of candidate SPSs; and
determining the current SPS as the serving SPS for the current video sample; and
in response to the current SPS being in the list of candidate SPSs:
looking up the current SPS from the list of candidate SPSs; and
determining the current SPS as the serving SPS for the current video sample.

11. The method of claim 1, wherein determining the serving SPS for the current video sample comprises:
extracting from the bitstream, an SPS length indicator associated with the current video sample and indicating a length of the current SPS encapsulated in the current video sample;
in response to the length of the current SPS indicated by the SPS length indicator being 0, determining the serving SPS to be the previous SPS used for decoding the previous video sample; and
in response to the length of the SPS indicated by the SPS length indicator not being 0:
extracting from the bitstream, a location information of the current SPS;
parsing the bitstream to obtain the current SPS based on the location information; and
determining the current SPS as the serving SPS for the current video sample.

12. A device for video processing, the device comprising a memory for storing computer instructions and a processor in communication with the memory, wherein, when the processor executes the computer instructions, the processor is configured to cause the device to:
receive a bitstream comprising at least one video sample, the at least one video sample comprising a current video sample and a previous video sample, wherein each of the at least one video sample comprises at least one video frame, and wherein the each of the at least one video sample is associated with a serving sequence parameter set (SPS) for decoding the each of the at least one video sample;
determine the serving SPS for the current video sample as being one of following types:
a previous SPS already parsed from the bitstream and used for decoding the previous video sample;
a current SPS encapsulated in the current video sample; and
an SPS in a list of candidate SPSs; and
decode the current video sample based on the serving SPS for the current video sample and the determined type of the serving SPS.

13. The device of claim 12, wherein, when the processor is configured to cause the device to determine the serving SPS for the current video sample, the processor is configured to cause the device to:
extract from the bitstream, an SPS existence flag indicating whether the current video sample encapsulates the current SPS; and
in response to the SPS existence flag indicating that the current video sample encapsulates the current SPS:
extract from the bitstream, a location information of the current SPS;
parse the bitstream based on the location information, to obtain the current SPS; and
determine the current SPS as the serving SPS for the current video sample.

14. The device of claim 13, wherein, the processor is configured to further cause the device to:
in response to the SPS existence flag indicating that the current video sample does not encapsulate the current SPS, determine the previous SPS as the serving SPS for the current video sample.

15. The device of claim 12, wherein:
the each of the at least one video sample encapsulates an SPS;
the SPS encapsulated in the current video sample is the current SPS; and
when the processor is configured to cause the device to determine the serving SPS for the current video sample, the processor is configured to cause the device to:
extract from the bitstream, a SPS update status flag indicating whether the serving SPS is updated from the previous SPS used for decoding the previous video sample;
in response to the SPS update status flag indicating the serving SPS being updated from the previous SPS, determine the current SPS as the serving SPS; and
in response to the SPS update status flag indicating the serving SPS not being updated from the previous SPS, ignore and skip parsing the current SPS in the current video sample, and determining the previous SPS as the serving SPS for the current video sample.

16. The device of claim 12, wherein the current SPS is encapsulated in the current video sample in response to the current video sample being a start point of a random access request.

17. The device of claim 16, wherein, when the processor is configured to cause the device to determine the serving SPS for the current video sample, the processor is configured to cause the device to:
in response to the current video sample being a start point of a random access request, determine the current SPS as the serving SPS for the current video sample.

18. The device of claim 12, wherein, the processor is configured to further cause the device to:
storing the serving SPS for the current video sample;
receiving a next video sample following the current video sample from the bitstream;
determining that the serving SPS for the next video sample is not updated from the serving SPS for the current video sample; and
decoding the next video sample based on the serving SPS for the current video sample.

19. A non-transitory storage medium for storing computer readable instructions, the computer readable instructions, when executed a processor in a device for video processing, causing the processor to:
receive a bitstream comprising at least one video sample, the at least one video sample comprising a current video sample and a previous video sample, wherein each of the at least one video sample comprises at least one video frame, and wherein the each of the at least one video sample is associated with a serving sequence parameter set (SPS) for decoding the each of the at least one video sample;
determine the serving SPS for the current video sample as being one of following types:
a previous SPS already parsed from the bitstream and used for decoding the previous video sample;
a current SPS encapsulated in the current video sample; and
an SPS in a list of candidate SPSs; and
decode the current video sample based on the serving SPS for the current video sample and the determined type of the serving SPS.

20. The non-transitory storage medium according to claim 19, wherein, when the computer readable instructions cause the processor to determine the serving SPS for the current video sample, the computer readable instructions cause the processor to:
extract from the bitstream, an SPS existence flag indicating whether the current video sample encapsulates the current SPS; and
in response to the SPS existence flag indicating that the current video sample encapsulates the current SPS:
extract from the bitstream, a location information of the current SPS;
parse the bitstream based on the location information, to obtain the current SPS; and
determine the current SPS as the serving SPS for the current video sample.
